(19) United States
(12) Patent Application Publication
(10) Pub. No.: US 2011/0070014 A1
(43) Pub. Date: Mar. 24, 2011

(54) Applicator for Paint and Other Liquids

(76) Inventor: Steven Armstrong, San Juan Capistrano, CA (US)

(21) Appl. No.: 12/788,296

(22) Filed: May 26, 2010

Related U.S. Application Data
(60) Provisional application No. 61/217,088, filed on May 26, 2009.

(51) Int. Cl. B05C 17/03

(52) U.S. Cl. 401/208

(57) ABSTRACT

An applicator for the application of different liquids such paint, sun-tan lotion, adhesives and other decorative or functional coatings to a multitude of surfaces. The applicator has a liquid reservoir sized to held in a hand of a user, having a housing that retains a roller adjacent to the reservoir.

### CROSS REFERENCE TO RELATED APPLICATION

This application claims priority to U.S. Provisional Patent Application Ser. No. 61/217,088, filed May 26, 2009 entitled Applicator for Paint and Other Liquids, Armstrong, Steve, which application is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

This invention relates to liquid applicators and more particularly to a method and apparatus for a hand-held roller applicator for paint and other liquids.

### BACKGROUND OF THE INVENTION

There are a number of hand-held liquid roller applicators including a reservoir that may be used for paint and other liquids. These smaller applicators are useful, for example, to paint a small sample area to preview a paint color on a wall, or for touching up paint on an existing painted wall. These applicators are also useful for applying smaller volumes of other liquids.

It is convenient to include a reservoir in such applicators, allowing continuous application of the liquid, such as paint, without having to apply liquid to the applicator in a separate container to remoisten the applicator. Serio et al., U.S. patent publications 2005/0169693 and 2006/0067784 and Bennett et al. U.S. Pat. No. 6,053,650 disclose hand-held paint applicators having an integral reservoir or removable container, but the roller portion of the Serio and other such devices have relatively narrow applicator rollers. Bullivant U.S. Pat. No. 7,338,227 and de Vreeze et al. U.S. Pat. No. 4,555,195 disclose such paint applicators with broader rollers, but they are held perpendicularly, pressing on the roller portion centrally rather than with a more even pressure that could be achieved holding the applicator by a surface, such as the reservoir, whose size and shape is roughly coextensive with the applicator roller.

It would be desirous to have a hand-held liquid applicator that can be held in a way to allow an even pressure on the roller portion. It would also be desirous to have a hand-held liquid applicator that can be stood on end for filling and without having to first disassemble the applicator.

It would also be desirous to have a single-use applicator that could be stood on end and be machine-filled, useful, for example, for selling small paint samples to customers to try different shades on their walls.

### BRIEF DESCRIPTION OF THE DRAWINGS

FIG. 1 is a left front perspective view of the present invention.

FIG. 2 is a right side exploded view of an embodiment of the present invention.

FIG. 3 is a perspective view of an embodiment the present invention.

FIG. 4 is a side cross-section view of one embodiment of the present invention.

FIG. 5 is top cross-section view of the present invention.

FIGS. 6A-6G are a series of views of the preferred embodiment of the invention demonstrating use of the invention.

FIG. 7 is a side cross-section view of another embodiment of the invention.

FIG. 8 is a right side exploded view of the embodiment of FIG. 7.

FIG. 9 is an exploded perspective view of the preferred embodiment of the present invention.

FIG. 10 is a side cross-section view of the embodiment of FIG. 9.

FIGS. 11A-11C are a series of side cross-section views of the embodiment of FIG. 9 demonstrating function of the use of the flow valve.

FIGS. 12A-12C are left front perspective views of the embodiment of FIG. 9 showing function of the flow valve.

FIG. 13 is a rear perspective view of an embodiment of the present invention mounted on an extension member.

FIG. 14 is front perspective view of the invention used with a filling station.

### SUMMARY OF THE INVENTION

A solution to the above has been devised. The present invention is an applicator for the application of different liquids such paint, sun-tan lotion, adhesives and other decorative or functional liquid coatings to a multitude of surfaces. The applicator comprises a liquid reservoir, sized to held in a hand of a user, having a housing that retains a roller adjacent to the reservoir. The reservoir and roller are in liquid communication with a mechanism to dispense liquid from the reservoir onto the roller. The roller may be substantially coextensive in its major dimension with the reservoir for better control of the roller when holding the reservoir and applying liquid to a surface. In the preferred embodiment of the invention the reservoir is sized to contain about eight ounces or a quarter of a liter of liquid.

The reservoir of the applicator has a removable lid at one end to allow the filling and sealing of the reservoir. In one embodiment the reservoir of the applicator further includes internal agitator prongs to facilitate mixing of within the reservoir.

The mechanism that dispenses paint from the reservoir to the roller includes one or more supply apertures formed in the wall of the reservoir between the reservoir and the roller that allows liquid to flow from the reservoir into an intervening wet chamber located between the reservoir and the roller. The wet chamber, housing and roller are sized so that the wet chamber creates a seal against a side of the roller, to prevent paint from spilling from the wet chamber around the roller. The wet roller rotates through the wet chamber during use and thereby is wetted.

In the preferred embodiment the supply apertures are regulated with a paint flow valve having an actuating button to regulate the flow of liquid through the supply apertures; otherwise the paint or other liquid is allowed to flow unregulated by action of gravity from the reservoir to the roller. A vacuum release burp valve may be included on the reservoir to relieve any vacuum created in the reservoir as paint drains through the apertures. The supply apertures may be sealed before initial use with a ripcord having plugs formed in the ripcord to fill the one or more supply apertures.

The method and operation of the preferred embodiment is straightforward. An applicator of the present invention is provided, the lid is removed from the reservoir and paint or other liquid is poured into the reservoir. The user then affixes the lid to the reservoir and may optionally shake the applicator to mix the liquid. The user pulls the ripcord away from the applicator, thereby uncovering the supply apertures and allowing liquid to flow through the apertures and into the wet chamber. If a paint flow valve is included the user must also hold down the button allow liquid to flow onto and wet the roller. The user then holds the applicator by the reservoir, presses the roller onto a surface and moves the roller over the surface, dispensing the liquid onto the surface.

The applicator can be used with a device that dispenses paint, a filling station, for example by dispensing both a base color paint and a tint into the reservoir of the applicator, and therefore is particularly suited to the sale of paint samples to cover a test area or for small projects. A filling station might be used to dispense paint samples into an applicator for a customer of a paint store so that the customer can take the sample home to apply it to walls and appraise the paint.

### DESCRIPTION OF THE INVENTION AND PREFERRED EMBODIMENT

The following description, and the figures to which it refers, are provided for the purpose of describing examples and specific embodiments of the invention only and are not intended to exhaustively describe all possible examples and embodiments of the invention.

A fillable applicator is provided for the application of different liquids by way of example and including but not limited to paint, sun-tan lotion, adhesives and other decorative and/or functional coatings to a multitude of surfaces. The present invention is a liquid applicator that evenly dispenses liquid on a roller and that has a liquid reservoir that is substantially coextensive with the roller and therefore can be held along the major axis of the roller for more control and even pressure on the roller.

Although the examples and embodiments used herein may refer to paint applicators, this is by way of example rather than limiting and the present invention is intended to also be used with various liquids that need to be evenly applied to a surface.

The present invention is particularly suited to applications that require a smaller amount of liquid, a reservoir of the present invention that is sized to be comfortably held in the hand. In the preferred embodiment of the invention the reservoir is sized to contain about eight ounces or a quarter of a liter of liquid. When used with any device that dispenses paint by dispensing both a base color paint and a tint, the reservoir must be of a minimum volume that can accept both the minimum volume of tint and required base-colored paint to be mixed with the tint.

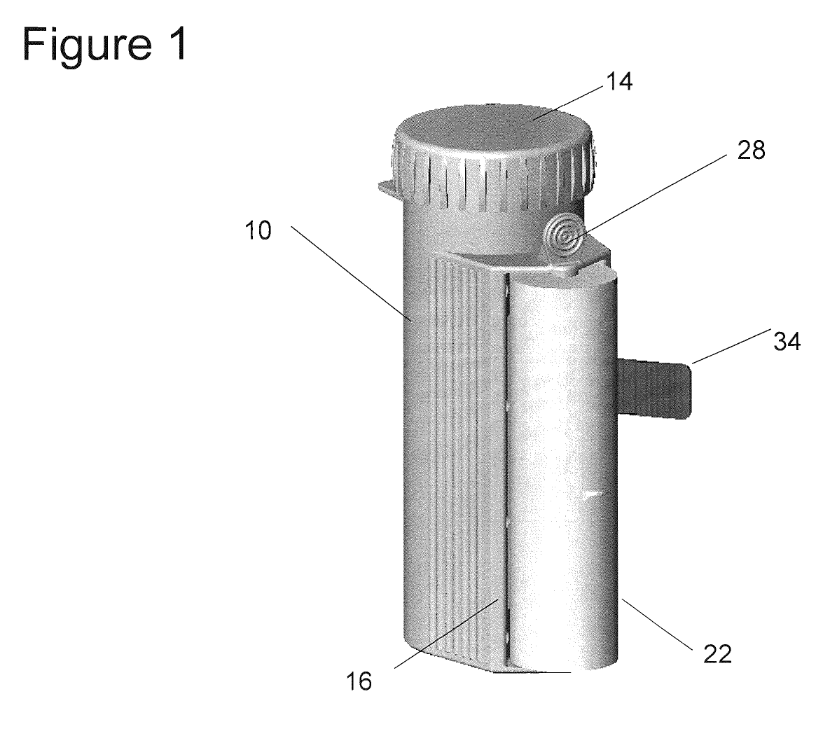

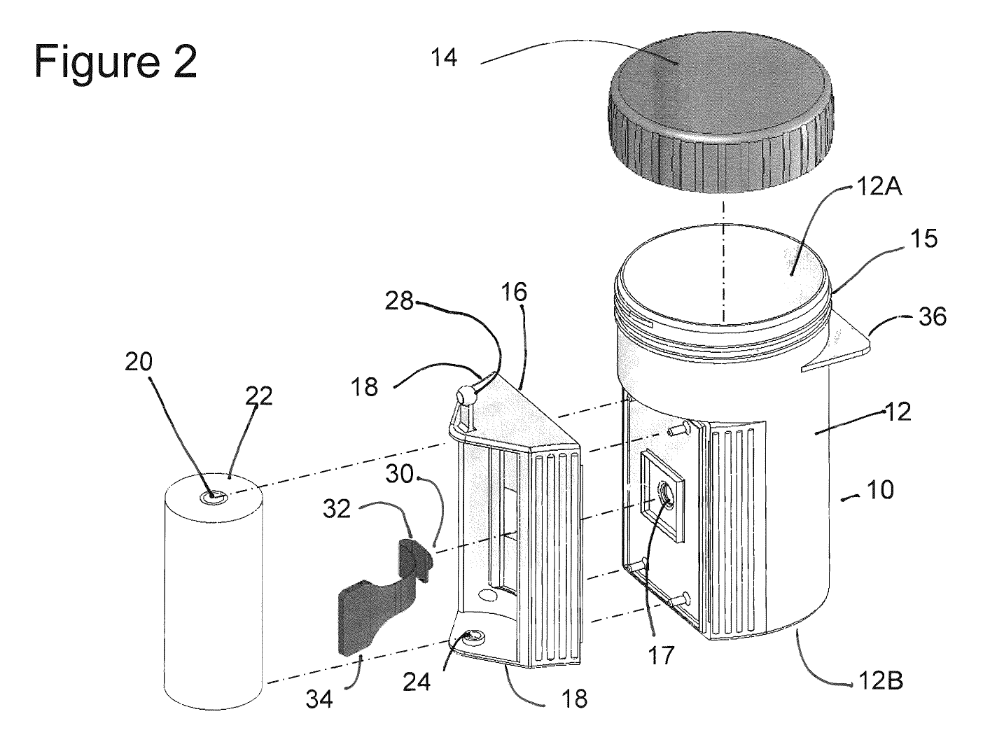

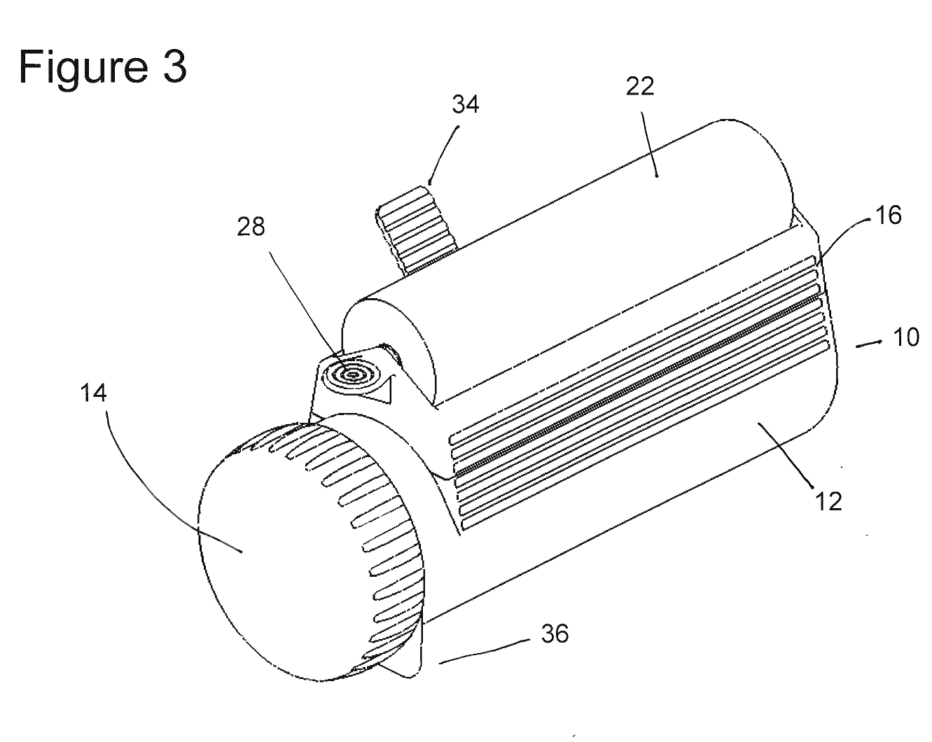

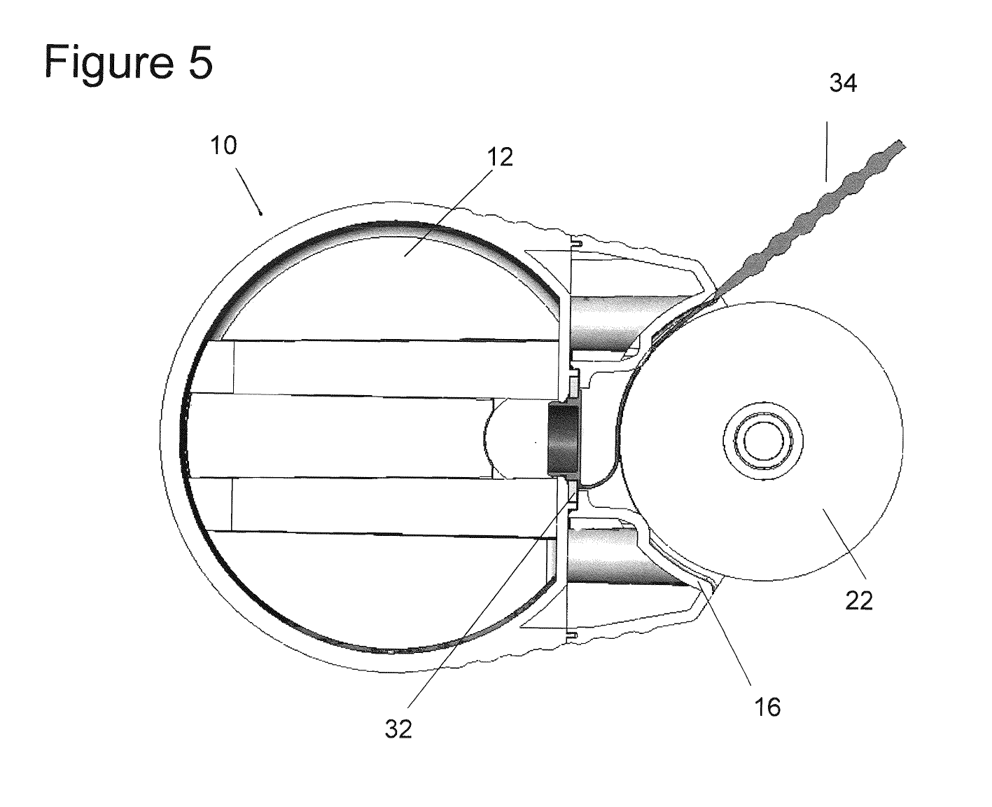

Referring to FIGS. 1-5 a paint applicator 10 that is sized to be held in the hand is shown, the paint applicator 10 includes a cylindrical reservoir 12. In the preferred embodiment the applicator is roughly six inches in its major dimension and the reservoir 12 holds about eight ounces or a quarter liter of liquid. The reservoir is open at the top end 12A and closed at the bottom end 12B.

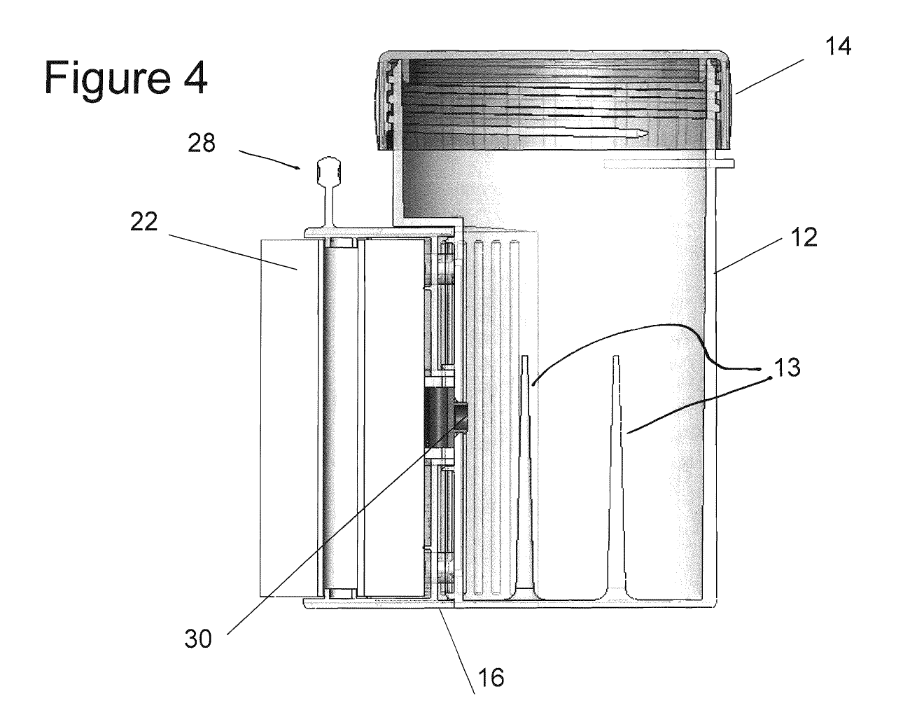

In some embodiments reservoir 12 includes one or more agitator prongs 13 located within the reservoir. The agitator prongs 13 may be formed at the interior of the bottom end of the reservoir 12 to aid in agitating paint stored in the reservoir. The top open end of the reservoir 12A is adapted to be capped with a lid 14. In the preferred embodiment the reservoir is formed with helical threads 15 complementary to helical threads within the lid 14 (partially shown in FIGS. 4, 10 and 11A-11C) to allow the lid to be screwed securely on to cover the open end.

The front side of the reservoir 10 is adapted to be fixedly attached to a roller housing 16. One or more supply apertures 17 are formed in the wall of the reservoir 12 to allow liquid paint placed in the reservoir to pass through to a wet chamber 26 formed in the roller housing 16 adjacent the one or more supply apertures 17.

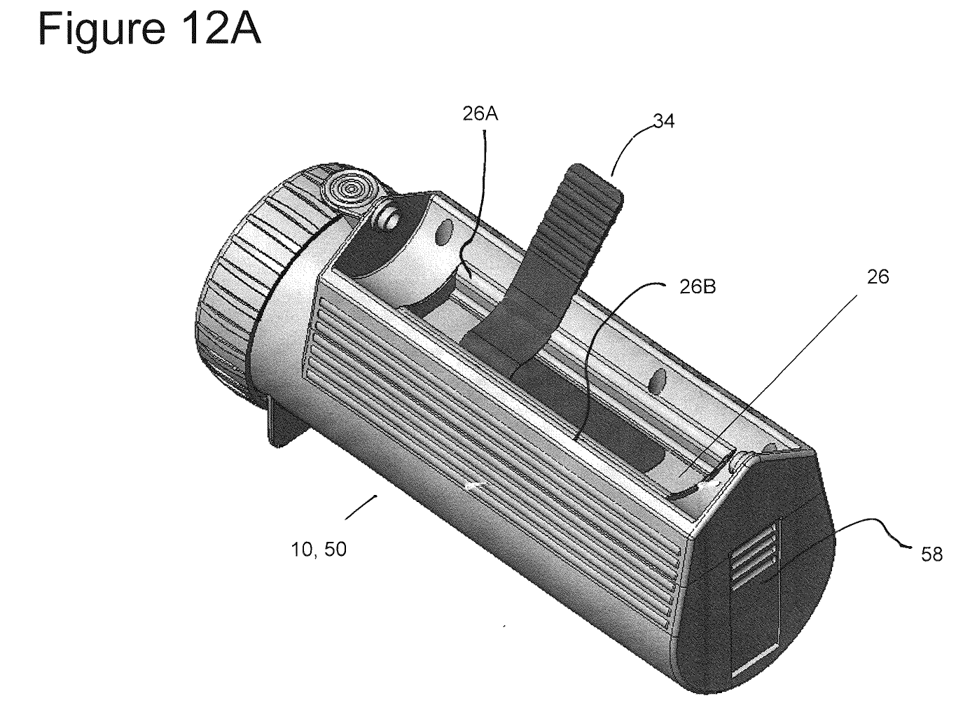

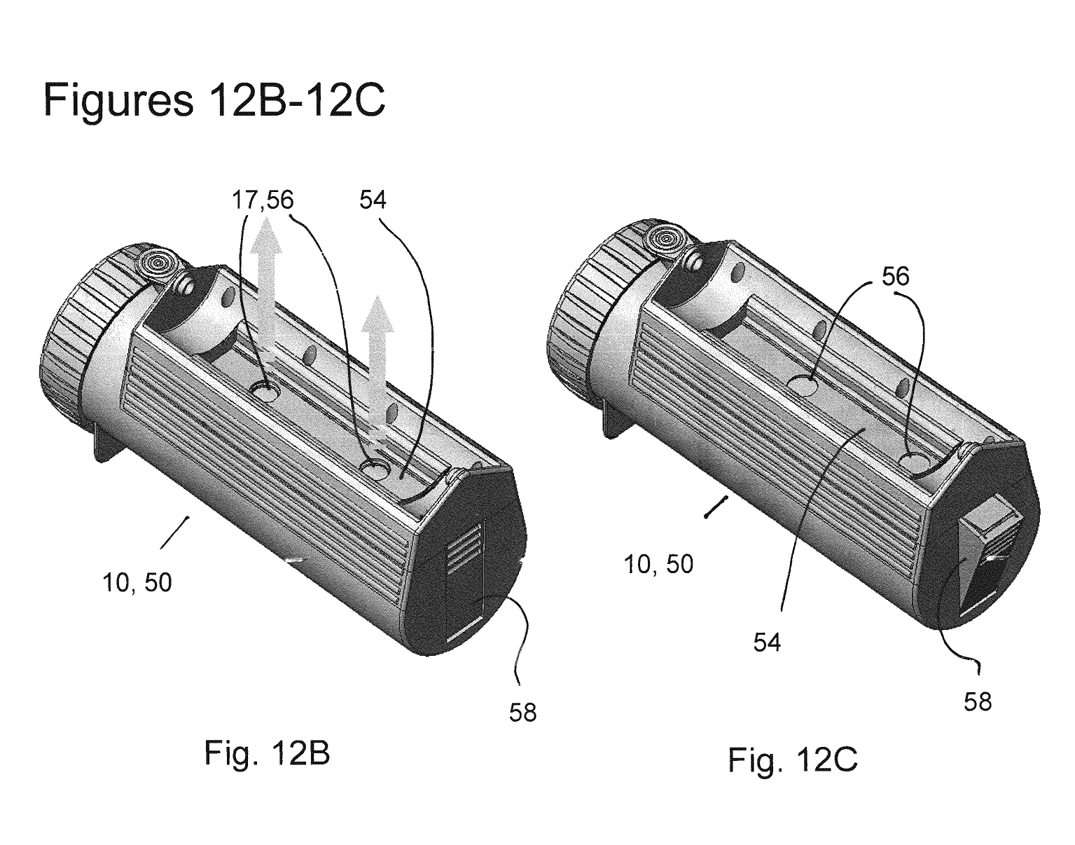

The roller housing 16 is formed with roller housing flanges 18 adapted to receive the axle 20 of a foam or nap painting roller 22. As shown in FIG. 12A, below, the wet chamber 26 is formed with wet chamber seal flanges 26A and 26B forming a wet seal that forms a seal against a side of the roller 22 to prevent paint from spilling from the wet chamber around the roller. In the preferred embodiment two supply apertures 17 are formed in the roller housing 16 for more even distribution of the paint along the major axis of the roller 22. Retaining pins 24 are formed on each housing flange 18 to frame and retain the roller 22, allowing the roller to rotate along its major axis. The one or more apertures are positioned relative the roller 22 to operably function to cause liquid paint stored in the reservoir to seep into the wet chamber 26 and the roller is sized large enough in diameter to dip into the wet chamber 26 as it rotates to absorb the paint escaping through the one or more supply apertures 17.

With the exception of the foam or nap roller, the parts of the present invention are preferably made from a polypropylene plastic using standard injection molding techniques that are known to those of skill in the art. One or more of the parts may be made from alternative materials however, such as metal or glass or other material and these alternative materials are intended to be within the scope of the present invention.

It is preferred that one of the roller housing flanges 18 include a roller release tab 28 to allow a user to more easily move the flange to release the roller 22 for removing or inserting the roller axle 20 into the retaining pins 24.

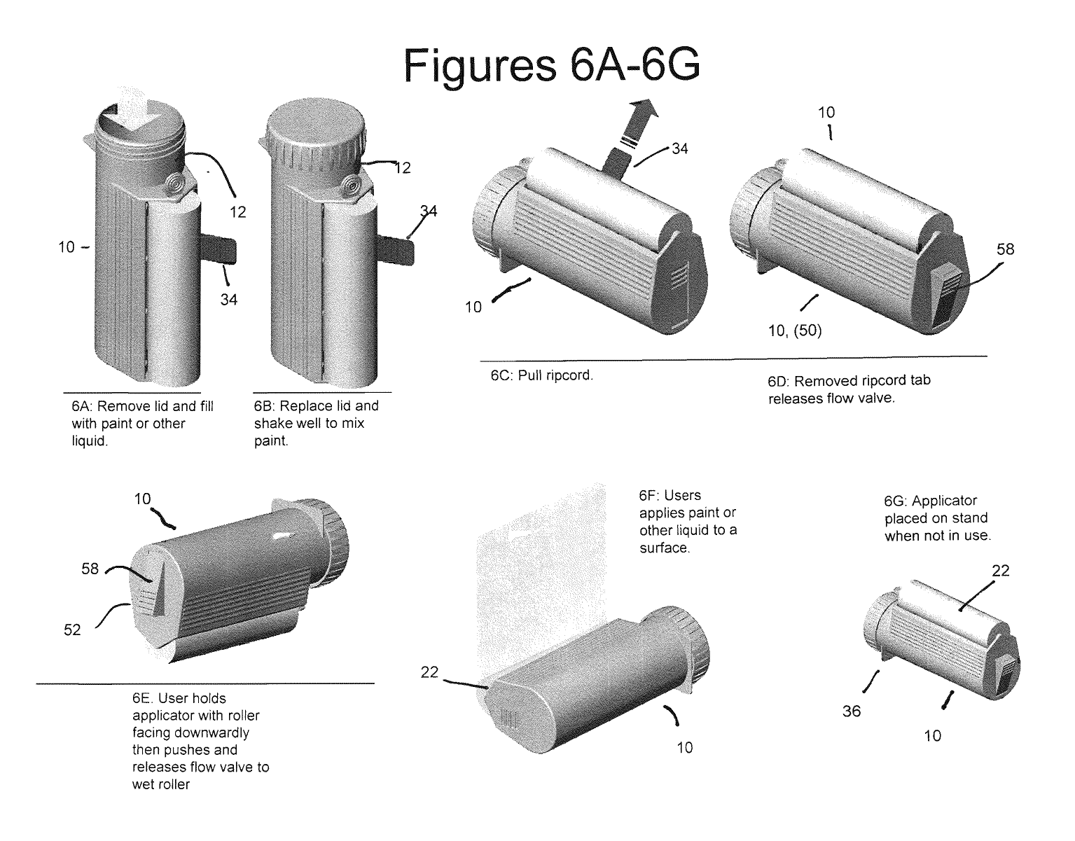

Referring now additionally to FIGS. 6A-6G, in operation the supply apertures 17 are initially fitted with one or more plugs 30 integrally formed on plate portion 32 of a ripcord 34, to keep paint from escaping through the one or more supply apertures 17 into the wet chamber 26. The ripcord 34 is preferably of sufficient overall length that it can extend past the roller 22 when the one or more apertures 17 are sealed with one or more plugs 30.

Use and operation of the paint applicator 10 is shown in FIGS. 6A through 6G for the preferred embodiment, shown below. The operation is of the preferred embodiment but is also illustrative of the operation of the various embodiments of this invention.

In operation the lid 14 is removed from the reservoir 12 and paint is poured in to fill the reservoir, as shown in FIG. 6A. The user then affixes the lid 14 to the reservoir 12 in FIG. 6B and, in most cases, a user shakes the applicator 10 to mix the paint.

FIGS. 6C and 6D show the activation of the paint applicator for use after it has been filled, in this example, with some paint. The ripcord 34 is pulled away from and separated from the paint applicator 10, causing the one or more plugs 30 of the ripcord to be withdrawn from and thereby unseal the one or more corresponding supply apertures 17.

In FIG. 6E the paint roller 22 of the paint applicator 10 is oriented downwardly so that paint from the paint reservoir 12 flows through the supply apertures 17 to wet the roller with paint. In this depiction the preferred embodiment is shown, which includes a wedge-shaped paint flow valve button 58. In the preferred embodiment the paint flow through the supply apertures 17 can be thus regulated, otherwise the paint is allowed to flow by action of gravity.

FIG. 6F shows wet roller applying paint to a surface, here with the roller 22 held horizontally to paint a wall, the valve 52 can be moved intermittently cause paint to flow to keep the roller wet with paint.

FIG. 6G shows a preferred and convenient way to store an already-wetted paint applicator on a surface, on a stand flange 36, which both keeps the paint applicator from rolling and keeps the roller 22 away from the surface to avoid getting paint on the surface. Note that the reservoir stand flange 36 is preferably formed on the reservoir to allow the paint applicator 10 to rest upon a surface and hold the supply apertures 17 and the roller 22 away from the resting surface, thereby also preventing paint from flowing through the supply apertures by action of gravity, as well as to keep the paint-soaked roller away from the surface.

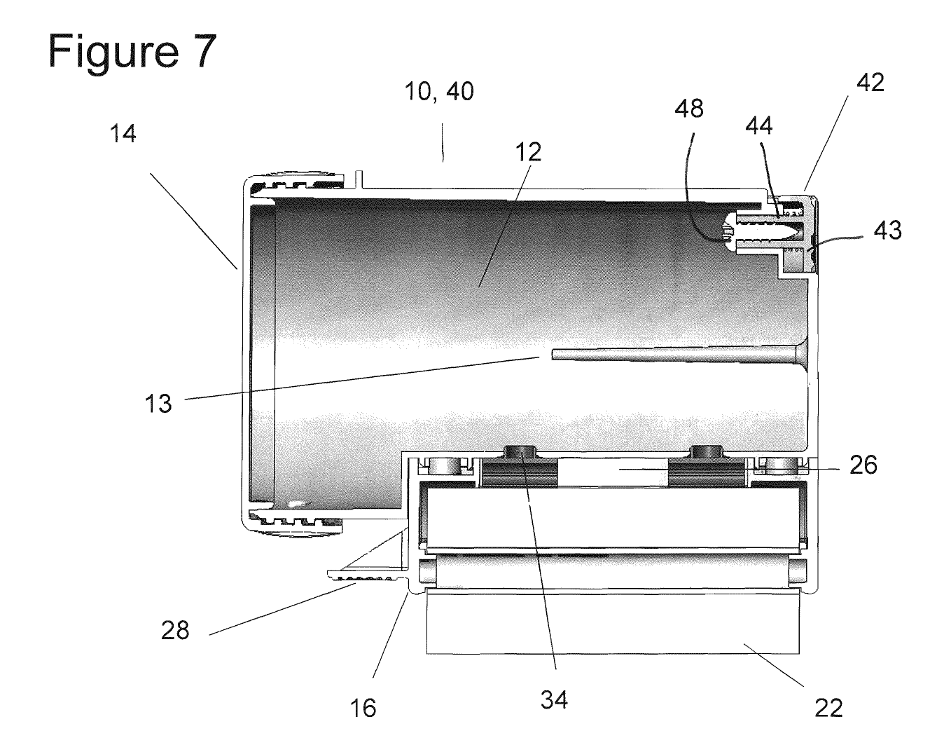

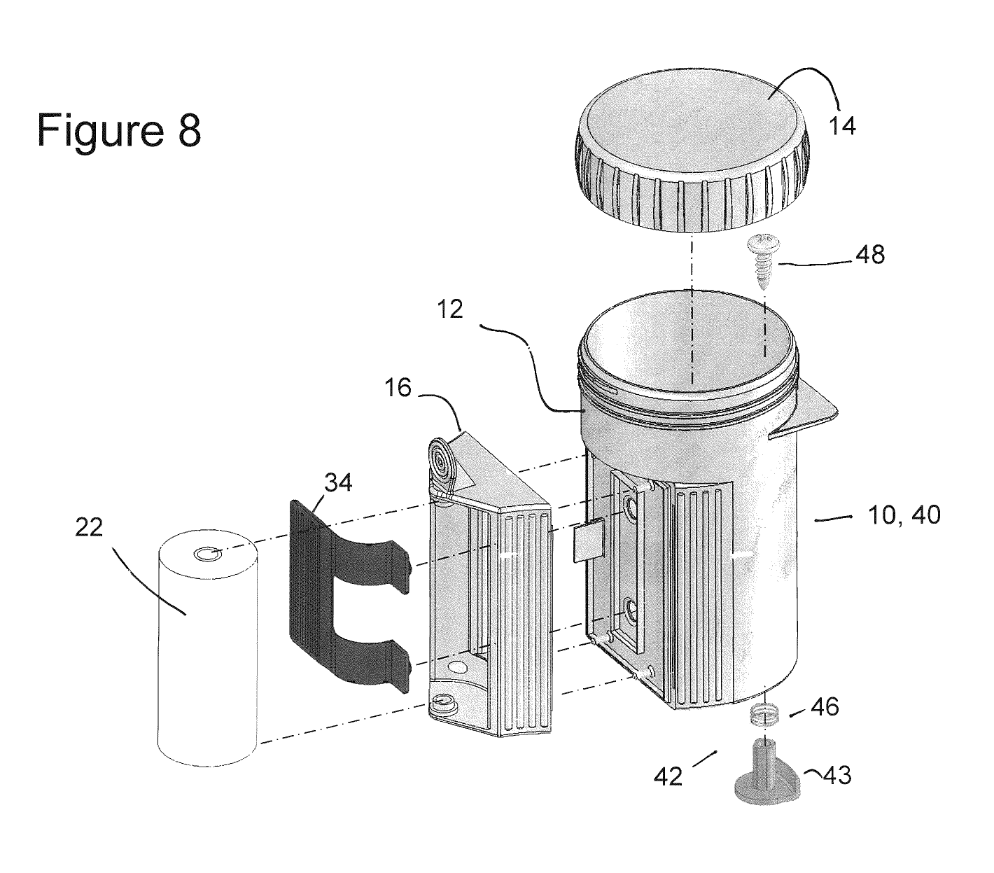

FIGS. 7 and 8 show another embodiment of the paint applicator 10, a paint applicator with vacuum release valve 40 also known as a burp valve 42. The burp valve 42 relieves any vacuum created when the reservoir 12 is sealed by lid 14 and paint is draining through the apertures 17, and then negative pressure relative to ambient pressure accumulates in the reservoir, restricting the draining of the paint.

The burp valve 42 comprises a plug 43 fitted into a burp valve aperture 44 in the reservoir 12, which may also form a notch to store the plug, and the aperture is located generally distal the roller housing 16. The burp valve plug 43 is biased by burp valve spring 46 to force the burp valve plug 43 outwardly through the aperture 44 away from the reservoir 12. The plug 43 is retained within the aperture 44 by adjustment screw 48 fastened centrally to the plug 43, whereby when the head of the screw is large enough to interfere with the edge of the aperture it prevents further travel of the burp valve plug.

In operation when the burp valve plug 43 is depressed by a user, it allows air to enter the reservoir 12 to equalize internal reservoir pressure with ambient pressure.

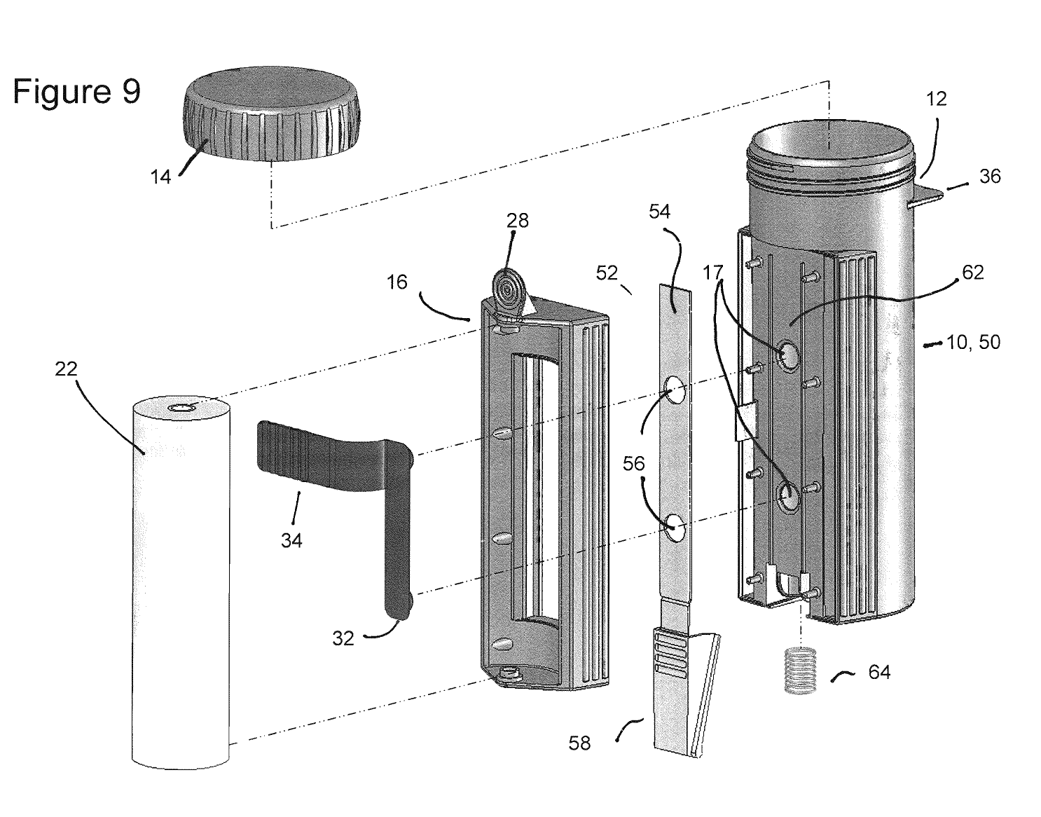

Referring additionally now to FIGS. 9-12C, the preferred embodiment of the invention is shown. A paint applicator 10, with a flow valve 50 embodiment is shown. This paint applicator includes flow valve 52 that functions to selectably occlude the supply apertures 17 and thereby regulate paint distribution to the roller 22. FIG. 12A also show wet chamber flanges 26A and 26B, that help to form a wet seal between the wet chamber 26 and the roller 22 to prevent paint from spilling from the wet chamber around the roller.

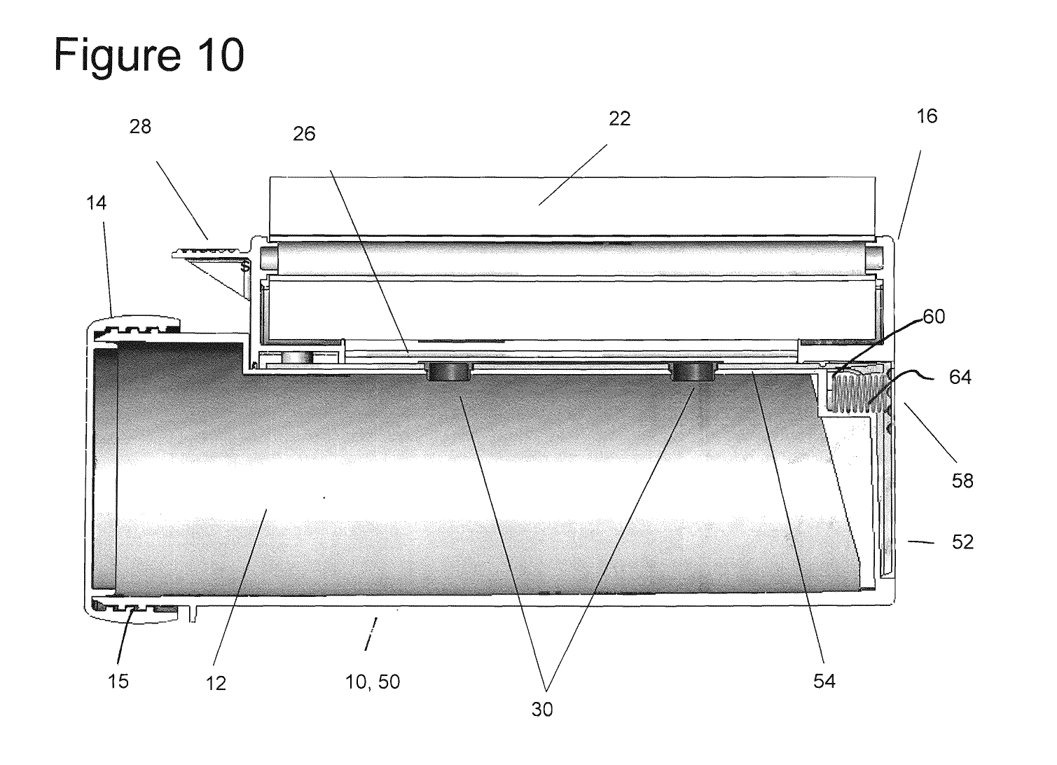

The flow valve 52 is a single flat member that has a slide plate portion 54 having flow valve slide portion apertures 56 and a valve button portion 58. The reservoir 12 is formed with a notch 60 to receive the button portion 58 of the flow valve 52. The roller housing 16 and reservoir 12 of the paint applicator 50 are formed to form a track 62 that retains the slide plate portion 54 of the flow valve 52 as it moves along the track. FIG. 10 is a side cross-section view showing the flow valve 52 in an initial, closed position, with the plugs 30 inserted both through the supply apertures 17 flow valve slide portion apertures 56, thereby locking the valve 52 in a closed position. The button portion 58 is formed from folding one end of the flow valve 52 and is biased outwardly with a flow valve spring 64.

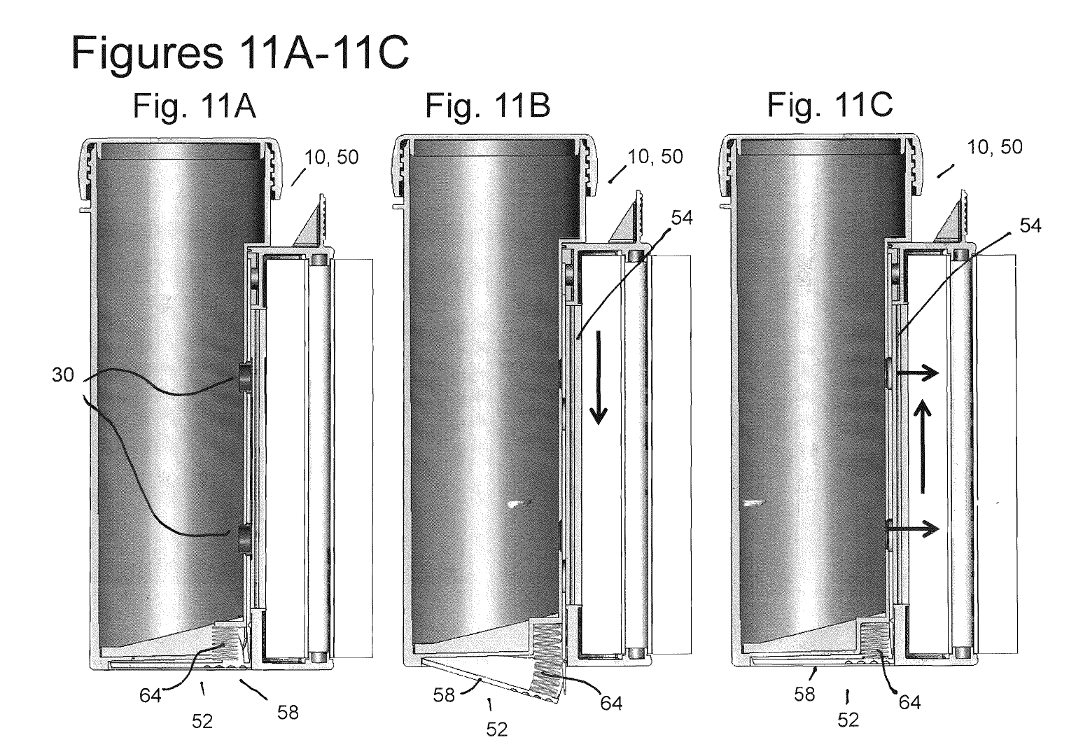

FIGS. 11A-11C are side cross-section views of the paint applicator 50 showing different positions of the flow valve 52; FIGS. 12A-12C are rear perspective views of the paint applicator 50 showing different positions of the flow valve 52 but where the roller 22 has been removed for illustration.

In the initial position, shown in FIGS. 11A and 12A, the plugs 30 of the ripcord 34 are initially fitted through supply apertures 17 and flow valve slide portion apertures 56 thereby preventing paint from seeping through the apertures 17.

When the ripcord 34 is removed, a spring 64 pushes the button 58 outwardly to cause the valve slide plate to move (shown with arrows in 11B-11C), thereby misaligning the flow valve apertures 56 with the supply apertures 17 and occluding the supply apertures 17, leaving the paint applicator in a closed position where paint flow is stopped.

When the button 58 is pushed fully inwardly by a user to cause the valve slide 54 to a position where the flow valve apertures 56 and the supply apertures 17 are once again aligned, paint will flow through both the flow valve apertures 56 and the supply apertures 17 (shown with arrows in FIGS. 11C and 12B). In this open position paint flows from the reservoir 12 into the wet chamber 26 to wet the roller 22, thereby allowing a user to selectably add paint to the roller.

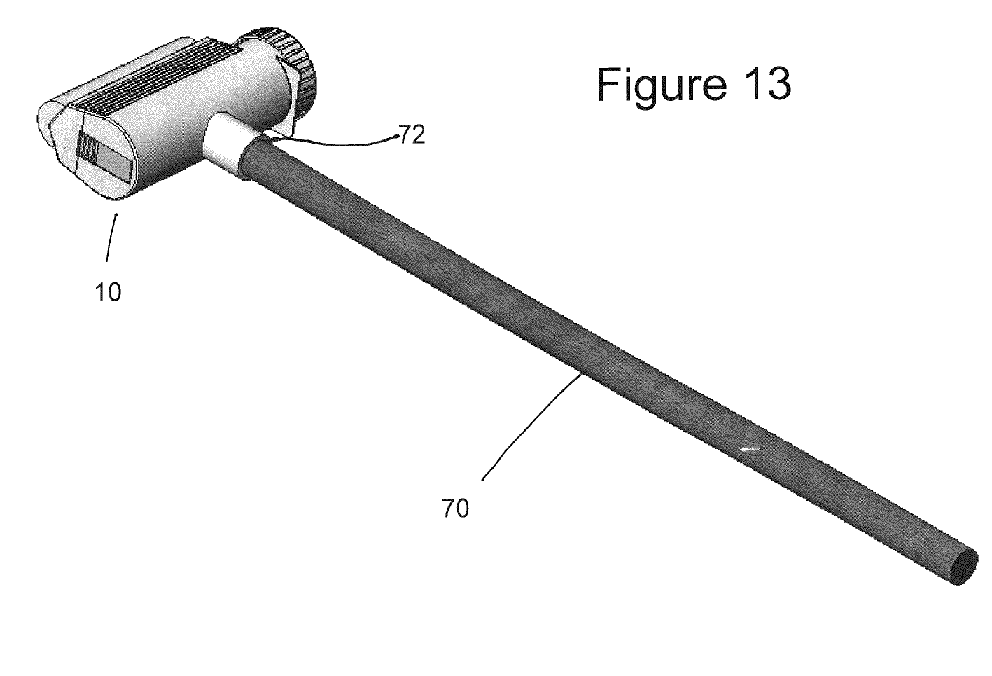

FIG. 13 shows an embodiment of present invention including an extension member 70 to allow the applicator to be held at a distance during use. The paint applicator 10 is formed with an extension member connector 72, in the case a collar, to receive and the extension member 70. Various extension members 70 and extension member connectors 72 can of course be used.

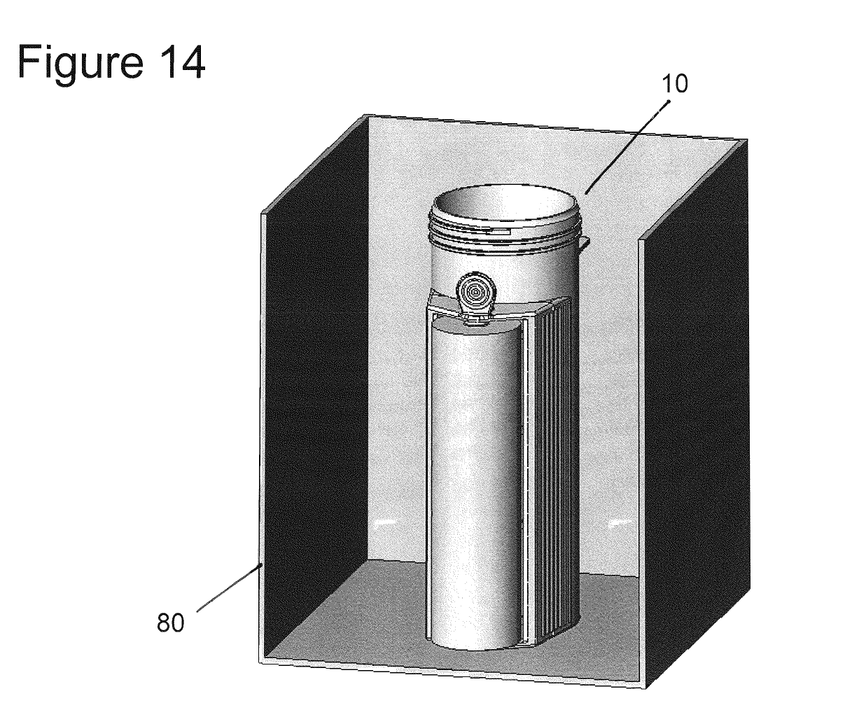

FIG. 14 is front perspective view of the applicator 10 shown used with a with a receiving area of a filling station 80. A filling station might, for example, dispense paint samples into the applicator 10 for a customer of a paint store, so that the customer can take the sample home to apply it to walls and appraise the paint. In this example the reservoir 12 with any device that dispenses paint by dispensing both a base color paint and a tint, the reservoir must have at least a minimum volume that can accept both the minimum volume of tint that is dispensed by the paint dispenser and the required base-colored paint volume to be mixed with the tint.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention. Accordingly, it is intended that all such additions, deletions, changes and alterations be included within the scope of the claims below.

What is claimed is:

1. An applicator for the application of different liquids, comprising:
a reservoir sized to held in a hand of a user, having a housing that retains a roller adjacent to the reservoir, where the reservoir and roller are in liquid communication.
